(19) United States
(12) Patent Application Publication
(10) Pub. No.: US 2026/0290848 A1
(43) Pub. Date: Sep. 24, 2026

(54) ELECTROCHEMICAL CELL

(71) Applicant: Saudi Arabian Oil Company, Dhahran (SA)

(72) Inventors: Aqil Jamal, Dhahran (SA); Alexey Izgorodin, Dhahran (SA)

(21) Appl. No.: 19/085,580

(22) Filed: Mar. 20, 2025

(51) Int. Cl. H01M 4/86; H01M 8/0271; H01M 8/04082; H01M 12/06; H01M 12/08; H01M 50/184; H01M 50/609

(52) U.S. Cl. CPC H01M 4/8663; H01M 8/0271; H01M 8/04201; H01M 12/06; H01M 12/08; H01M 50/184; H01M 50/609

(57) ABSTRACT

An electrochemical cell includes a housing, a first electrode, a second electrode, and a contacting layer. The housing defines a first compartment, a gas inlet, a second compartment, and a fluid inlet. The first electrode is porous and disposed within the first compartment. The second electrode is disposed within the second compartment. The contacting layer is disposed within the housing intermediate of the first and second compartments. The contacting layer hermetically separates the first and second compartments. The contacting layer is permeable for allowing the fluid within the second compartment to permeate through the contacting layer and establish fluid communication amongst the gas, fluid, and first electrode. The contacting layer restricts flow of the gas from the first compartment through the contacting layer to the second compartment.

### TECHNICAL FIELD

This disclosure relates to electrochemical cells.

### BACKGROUND

Electrochemical cells generate electrical energy from chemical reactions. Electrical energy can also be applied to electrochemical cells to cause chemical reactions to occur. Electrochemical cells that generate an electric current can be called voltaic or galvanic cells. Electrochemical cells that perform electrolysis can be called electrolytic cells. Electrochemical cells can be used in a wide variety of applications, such as energy storage and chemicals production.

### SUMMARY

This disclosure describes technologies relating to electrochemical cells.

The subject matter described in this disclosure can be implemented in particular implementations, so as to realize one or more of the following advantages. The described electrochemical cells enable independent mass transport of gaseous reactants, liquid reactants, gaseous products, liquid products, or any combinations of these. The described electrochemical cells mitigate and/or eliminate the negative effect of gas crossover. Gas crossover occurs when gas molecules permeate through the cell's membrane from one electrode to the other, which can negatively affect the cell's efficiency and performance, for example, by causing undesired reactions. The described electrochemical cells can improve safety in comparison to conventional cells and allow for use of intermittent renewable energy sources with broad capacity range because of independent control of and low resistance to mass transfer of gaseous reactants/products. The described electrochemical cells can improve energy efficiency of gas developing electrolytic reactions and processes because of low electrolyte resistance and high active surface area in the absence of gas bubbles. The described electrochemical cells enable industrially relevant and long-term stability/efficiency for gas consuming electrochemical reactions and processes. For example, conventional gas consuming electrolytic cells have lifetimes as short as about 100 hours and rarely exceed a few thousand hours, which can hinder overall commercial viability of such processes. The described electrochemical cells enable reduction of plant balancing, for example, by mitigating and/or eliminating the need for gas-liquid separation, purification, and heat management equipment. The described electrochemical cells can be broadly applied in gas developing and/or gas consuming electrolytic reactions and processes.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1A is a schematic diagram of an example electrochemical cell.

FIG. 1B is a schematic diagram of various components of the electrochemical cell of FIG. 1A.

FIG. 1C is a schematic diagram of various components of the electrochemical cell of FIG. 1A.

FIG. 2A is a schematic diagram of an example electrochemical cell.

FIG. 2B is a schematic diagram of an example electrochemical cell system.

FIG. 2C is a schematic diagram of an example electrochemical cell system.

FIG. 2D is a schematic diagram of an example electrochemical cell system.

FIG. 2E is a schematic diagram of an example electrochemical cell system.

FIG. 3 is a flow chart of an example method of operating an electrochemical cell.

### DETAILED DESCRIPTION

Electrochemical cells can be used in wide variety of applications ranging from energy storage to chemicals production and are fundamental to realize the global transition to clean energy use. The use of renewable energy sources (such as wind and solar) with inherent variability of electricity supply and gaseous feedstocks (such as carbon dioxide) introduces the need for a wider operating envelop, including a low minimum load operation and sufficient ramp up rates. In addition, variable electricity supply limits the number of operating hours of an industrial plant and underlines the importance of decreasing system capital costs and maintenance requirements. As one example, commercial systems for electrochemical hydrogen and oxygen production from water typically require operating at over 50% capacity due to the high volume-fraction of hydrogen in oxygen at lower capacity.

Conventional electrochemical cells can be difficult to integrate and can be very inefficient. In particular, electrodes are often submerged in electrolyte solution in conventional electrochemical cells, which prevents their use for gas consuming processes. In gas developing processes, bubbles formed at the interface between the electrode and the electrolyte can reduce active electrode surface area and can contribute to high electrical resistance of the cell. Bubble formation further necessitates complex apparatuses to separate and purify the produced gas stream.

This disclosure describes electrochemical cells with a wide operating envelope. The electrochemical cell includes a gas portion, a liquid portion, and a contacting layer. The gas portion includes a gas and a hydrophobic additive in contact with a porous electrode. The liquid portion includes a liquid and a composite interlayer (CIL). The CIL allows for low resistance multidirectional liquid flow and maintains consistent pressure of the liquid within its structure across a specified height difference. The liquid portion includes an inlet and an outlet for flow of the liquid through the liquid portion. In some implementations, the outlet exhibits a greater flow resistance in comparison to the inlet. In some implementations, the inlet exhibits a greater flow resistance in comparison to the outlet. Having mismatching flow resistance between the inlet and outlet can enable uniform flow of electrolyte through the electrochemical cell, especially in multicell configurations including multiple electrochemical cells, while maintaining equilibrium pressure between the gas(es) and electrolyte within the cell(s). In cases where the outlet exhibits a greater flow resistance in comparison to the inlet, flow can be controlled by decreasing liquid pressure in the outlet manifold (e.g., pumping out of the outlet manifold). In cases where the inlet exhibits a greater flow resistance in comparison to the outlet, flow can be controlled by increasing liquid pressure in the inlet manifold (e.g., pumping into the inlet manifold). The contacting layer hermetically separates the gas portion and the liquid portion. The contacting layer includes a composite microporous layer (CML) and a composite support layer (CSL). The CML has predominantly transverse permeability and maintains the hermetic seal. The CSL has a greater liquid holding capacity in comparison to the CML and maintains consistent pressure of the liquid within its structure across a specified height difference. The described electrochemical cells enable independent mass transport of gaseous and liquid reactants and products while negating the effects of gas crossover. The described electrochemical cells improve energy efficiency of gas developing electrolytic reactions and processes.

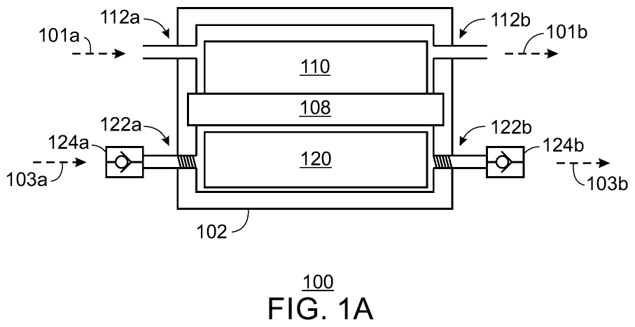

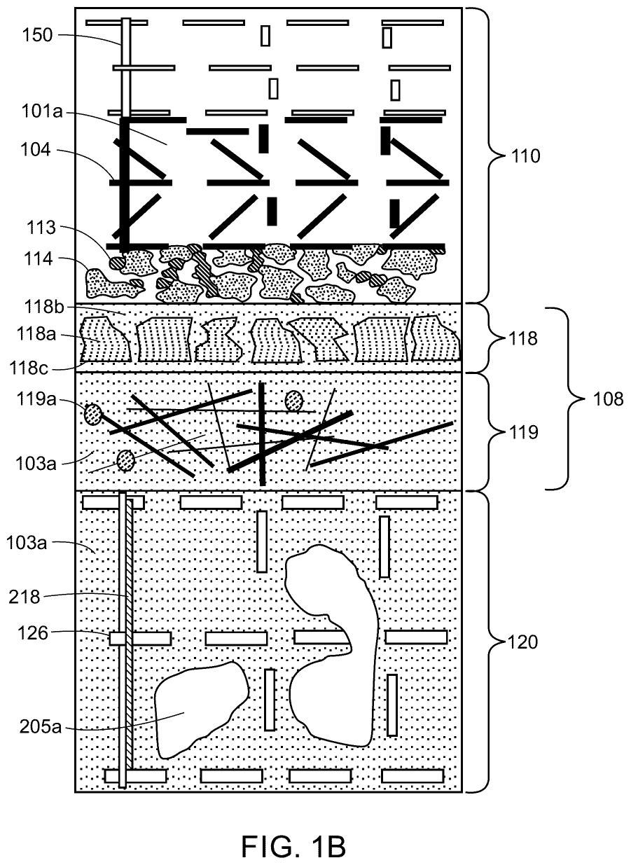

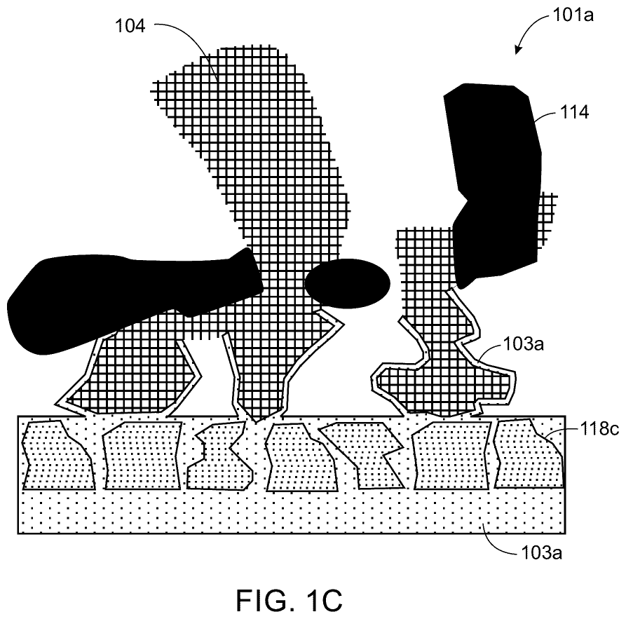

FIG. 1A is a schematic diagram of an example electrochemical cell 100. A gas 101a and a fluid 103a including an electrolyte can be flowed to the cell 100. Electrical power can be supplied to the cell 100. The cell 100 utilizes the supplied electrical power to facilitate a reaction between the gas 101a and the fluid 103a for producing a desired product. The cell 100 produces an outlet gas 101b and an outlet fluid 103b. In some implementations, the outlet gas 101b includes the desired product. In some implementations, the outlet fluid 103b includes the desired product. In some implementations, the outlet gas 101b includes a first desired product, and the outlet fluid 103b includes a second desired product. As an example, a desired product as a liquid phase can be produced during operation of the cell 100, condensed from the gas 101a, or both. The desired product as a liquid phase can mix with the fluid 103a as the outlet fluid 103b. As another example, reactant(s) in the fluid 103a can be consumed during operation of the cell 100, evaporated and mixed with the gas 101a as the outlet gas 101b, or both.

The cell 100 includes a housing 102, a first electrode 104, a second electrode 106, and a contacting layer 108. The housing 102 defines a first compartment 110 and a second compartment 120. The housing 102 defines a gas inlet 112a at the first compartment 110. The gas inlet 112a is configured to receive the gas 101a into the first compartment 110. The housing 102 defines a fluid inlet 122a at the second compartment 120. The fluid inlet 122a is configured to receive a fluid 103a into the second compartment 120. The fluid 103a includes an electrolyte. The fluid 103a can be a gaseous phase, a liquid phase, or a mixed phase that includes a gaseous phase and a liquid phase. The first electrode 104 is disposed within the first compartment 110. The second electrode 106 is disposed within the second compartment 120. The contacting layer 108 is disposed within the housing 102 between the first compartment 110 and the second compartment 120. The contacting layer 108 is configured to hermetically separate (seal) the first compartment 110 from the second compartment 120 while allowing fluid communication amongst the fluid 103a, the gas 101a, and the first electrode 104 (or in some cases, a catalyst 113 contacting the first electrode 104). The catalyst 113 can accelerate electrochemical reactions (e.g., redox reactions). A contacting boundary is formed between the first compartment 110 and the contacting layer 108. An example of the contacting boundary is shown in FIG. 1C and described in more detail later. In some implementations, the fluid 103a is mitigated and/or prevented from flowing into the first compartment 110 at differential pressures (difference in operating pressures of the fluid 103a in the second compartment 120 and the gas 101a in the first compartment 110) less than about 2 kilopascals (kPa), less than about 5 kPa, less than about 10 kPa, less than about 100 kPa, less than about 500 kPa, less than about 1,000 kPa, or less than about 3,000 kPa. For example, the fluid 103a can flow with low resistance between the contacting boundary and the second compartment 120 across the contacting layer 108 without flowing into the first compartment 110. Similarly, the gas 101a can be mitigated and/or prevented from flowing across the contacting layer 108 and flowing into the second compartment 120 at differential pressures less than about 2 kPa, less than about 5 kPa, less than about 10 kPa, less than about 50 kPa, less than about 100 kPa, less than about 500 kPa, less than about 1,000 kPa, or less than about 3,000 kPa.

The housing 102 can define a gas outlet 112b at the first compartment 110. The gas outlet 112b can be configured to discharge a gas 101b from the first compartment 110. The housing 102 can define a fluid outlet 122b at the second compartment 120. The fluid outlet 122b can be configured to discharge a fluid 103b from the second compartment 120. The flow resistance of the fluid outlet 122b can be greater than the flow resistance of the fluid inlet 122a. For example, fluid 103a can more easily flow into the second compartment 120 via the fluid inlet 122a in comparison to the fluid 103b flowing out of the second compartment 120 via the fluid outlet 122b. This difference in flow resistance can be due to various factors, such as cross-sectional flow area of the fluid inlet 122a versus that of the fluid outlet 122b (e.g., diameter size). In some implementations, the fluid inlet 122a exhibits a greater flow resistance in comparison to the fluid outlet 122b. Having mismatching flow resistance between the fluid inlet 122a and fluid outlet 122b can enable uniform flow of electrolyte through the electrochemical cell 100, especially in multicell configurations including multiple electrochemical cells 100, while maintaining equilibrium pressure between the gas(es) and electrolyte within the cell(s) 100. In cases where the fluid outlet 122b exhibits a greater flow resistance in comparison to the fluid inlet 122a, flow can be controlled by decreasing liquid pressure in the outlet manifold (e.g., pumping out of the outlet manifold). In cases where the fluid inlet 122a exhibits a greater flow resistance in comparison to the fluid outlet 122b, flow can be controlled by increasing liquid pressure in the inlet manifold (e.g., pumping into the inlet manifold).

Although shown in FIG. 1A as having a parallel flow configuration, the cell 100 can, in some implementations, have a counterflow configuration. For example, the gas inlet 112a and the gas outlet 112b can be switched, so that the general direction of flow of the gas 101a through the first compartment 110 is opposite of the general direction of flow of the fluid 103a through the second compartment 120.

In some implementations, the gas 101a is a product of combustion or another industrial or commercial process. For example, the gas 101a includes air, oxygen, hydrogen, carbon monoxide, methane, hydrogen sulfide, ammonia, methanol, propanol, water, or any combinations of these. The gas 101a can include, for example, emission from a source, such as a power plant, a manufacturing facility, a waste incinerator, a fireplace, an oven, a boiler, a smelter, a furnace, a steam generator, a vehicle, or any combinations of these. In some implementations, the gas 101a includes an organic compound. In some implementations, the gas 101a includes an inorganic compound. The organic compound and/or the inorganic compound of the gas 101a can be in the form of a gas, particles, aerosols, or any combinations of these. In some implementations, the difference in pressure between the gas 101a within the first compartment 110 and the fluid 103a within the second compartment 120 is in a range from about 0 kPa (kPa) to about 5,000 kPa, from about 0 kPa to about 3,000 kPa, from about 0 kPa to about 1,000 kPa, from about 0 kPa to about 100 kPa, or from about 0 kPa to about 10 kPa. In some implementations, the gas 101a within the first compartment 110 has an operating pressure in a range from 0 megapascals absolute (MPaₐ) to about 10 MPaₐ, from 0 MPaₐ to about 9 MPaₐ, from 0 MPaₐ to about 8 MPaₐ, from 0 to about 7 MPaₐ, from 0 MPaₐ to about 6 MPaₐ, from 0 MPaₐ to about 5 MPaₐ, from 0 MPaₐ to about 4 MPaₐ, from 0 MPaₐ to about 3 MPaₐ, from 0 MPaₐ to about 2 MPaₐ, or from 0 MPaₐ to about 1 MPaₐ. In some implementations, the gas 101a within the first compartment 110 has an operating temperature in a range from about −50 degrees Celsius (° C.) to about 500° C., from about 0° C. to about 250° C., or from about 0° C. to about 100° C. The outlet gas 101b produced by the cell 100 can include, for example, oxygen, hydrogen, chlorine, bromine, carbon monoxide, carbon dioxide, ethylene, methane, ammonia, methanol, propanol, water, nitrogen, or any combinations of these.

In some implementations, the cell 100 includes an inlet check valve 124a at the fluid inlet 122a. The inlet check valve 124a allows the fluid 103a to enter the second compartment 120 through the inlet check valve 124a but prevents the fluid 103a from exiting the second compartment 120 through the inlet check valve 124a. In some implementations, the cell 100 includes an outlet check valve 124b at the fluid outlet 122b. The outlet check valve 124b allows the fluid 103b to exit the second compartment 120 through the outlet check valve 124b but prevents fluid from entering the second compartment 120 through the outlet check valve 124b. The inlet check valve 124a and the outlet check valve 124b are one-way valves that allow fluid flow through the respective check valve in a specified direction but prevents fluid flow in an opposite direction.

The first electrode 104 is porous and is configured to connect to an external electrical power source for receiving electrical power. A voltage is established across the first electrode 104 and the second electrode 106 in response to the first electrode 104 receiving electrical power. The established voltage across the first electrode 104 and the second electrode 106 facilitates a chemical reaction between the gas 101a and the fluid 103a. In some implementations, the first electrode 104 includes microstructures, nanostructures, or both. Microstructures are structures that have dimensions on the order of micrometers (μm). For example, microstructures are structures that have at least one dimension sized less than 1 millimeter (mm) or from about 1 μm to about 999 μm. Nanostructures are structures that have dimensions on the order of nanometers (nm). For example, nanostructures are structures that have at least one dimension sized from about 1 nm to about 100 nm. Having microstructures and/or nanostructures can increase the surface area of the first electrode 104. Increasing the contact surface area of the first electrode 104 can increase the interaction of the first electrode 104 and the electrolyte of the fluid 103a at the interface with the contacting layer 108, thereby improving power usage efficiency of the cell 100. In some implementations, the first electrode 104 is made of a metal foam, such as a nickel-based foam or a metal alloy-based foam. In some implementations, the first electrode 104 is made of a metal foil, metal mesh, carbon fiber, carbon cloth, fibrous conductive substrates, or any combinations of these. For example, the first electrode 104 can include nickel, copper, platinum, gold, palladium, zinc, titanium, tin, molybdenum, cobalt, or any combinations of these (e.g., stainless steel). For example, the first electrode 104 can include a conductive substrate including polyvinylidene fluoride, polyaniline, polypyrrole, polythiophene, carbon nanotubes, graphene fibers, or any combinations of these. In some cases, fibers can be combined with each other and/or imbedded with metal nanoparticles. The first electrode 104 allows fluid communication between the gas 101a throughout the first compartment 110 and the electrolyte at the interface of the contacting layer 108. In some implementations, the first electrode 104 has high multilateral gas flow resistance and includes an adjacent porous layer having a lower multilateral gas flow resistance in comparison to the first electrode 104. For example, a material having a high multilateral gas flow resistance corresponds to a pressure drop greater than about 10 kPa per meter, greater than about 50 kPa per meter, or greater than about 100 kPa per meter within the material at a gas entry velocity of about 10 meters per second. For example, a material having a low multilateral flow resistance corresponds to a pressure drop of less than about 10 kPa per meter, less than about 5 kPa meter, or less than about 1 kPa per meter within the material at a gas entry velocity of about 10 meters per second. An example of the porous layer is shown in FIG. 1C and described in more detail later.

In some implementations, the cell 100 includes a low multilateral flow resistance layer 150. The layer 150 can be in contact with the first electrode 104. The layer 150 can be thicker than the first electrode 104 and can be made of a lower cost material in comparison to the first electrode 104. The layer 150 reduces gas flow resistance, thereby reducing the energy required to circulate the gas 101a through the cell 100, especially in cases in which the first electrode 104 exhibits high multilateral flow resistance and/or is very thin, so that gas circulation across the first compartment 110 is impractical (e.g., pressure drop exceeds 0.1 kPa, 1 kPa, 10 kPa, 50 kPa, or 100 kPa, depending on the application). In some implementations, the layer 150 is electrically conductive. In some implementations, the layer 150 is electrically non-conductive. The layer 150 can be made of a uniform material (e.g., foams or felts). The layer 150 can define flow channels and/or flow guides (e.g., stamped metal films or molded plastics, expanded meshes, and/or corrugated meshes or foils).

The cell 100 includes a hydrophobic additive 114. The hydrophobic additive 114 is disposed within the first compartment 110. The hydrophobic additive 114 is in contact with the first electrode 104. The hydrophobic additive 114 is configured to prevent clogging of pores of the first electrode 104 by the electrolyte of the fluid 103a. The hydrophobic additive 114 can facilitate transport of the gas 101a through the contacting boundary. In some implementations, the hydrophobic additive 114 includes polytetrafluoroethylene (PTFE), polyvinyulidene fluoride (PVDF), or both.

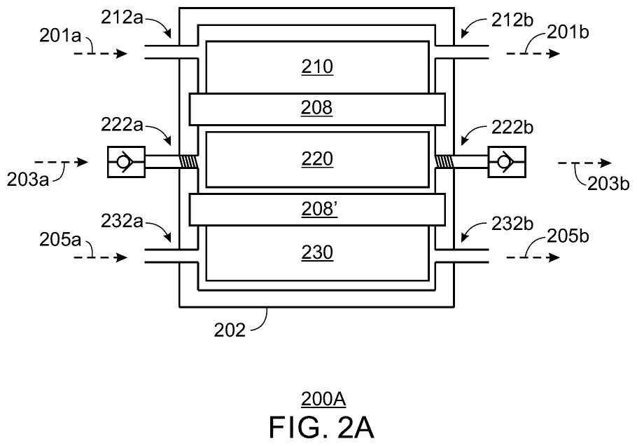

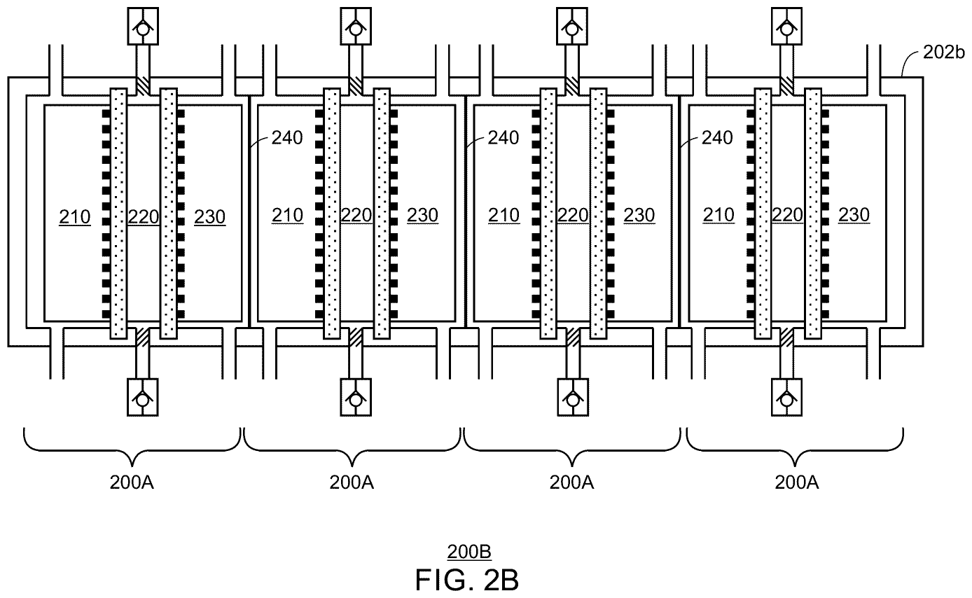

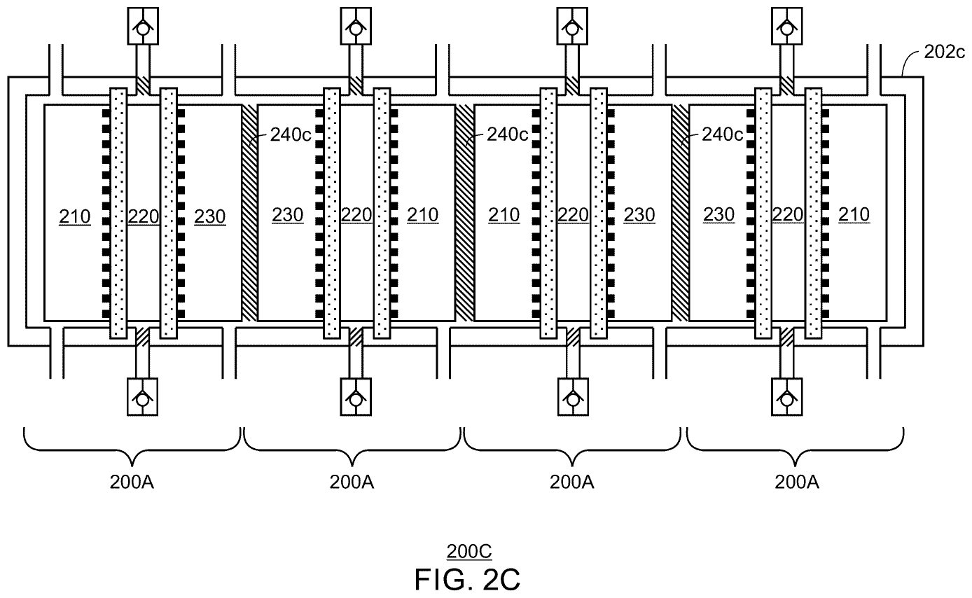

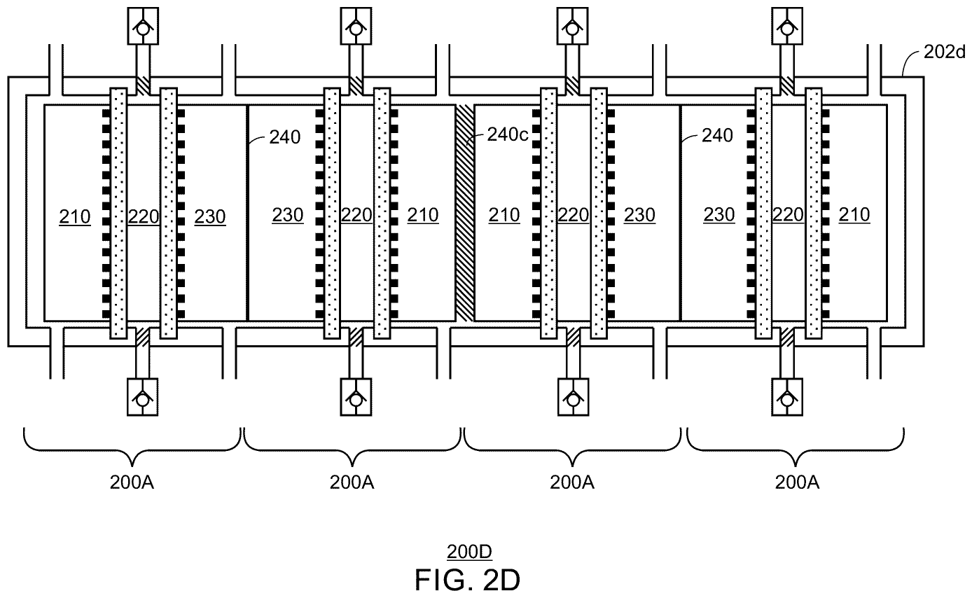

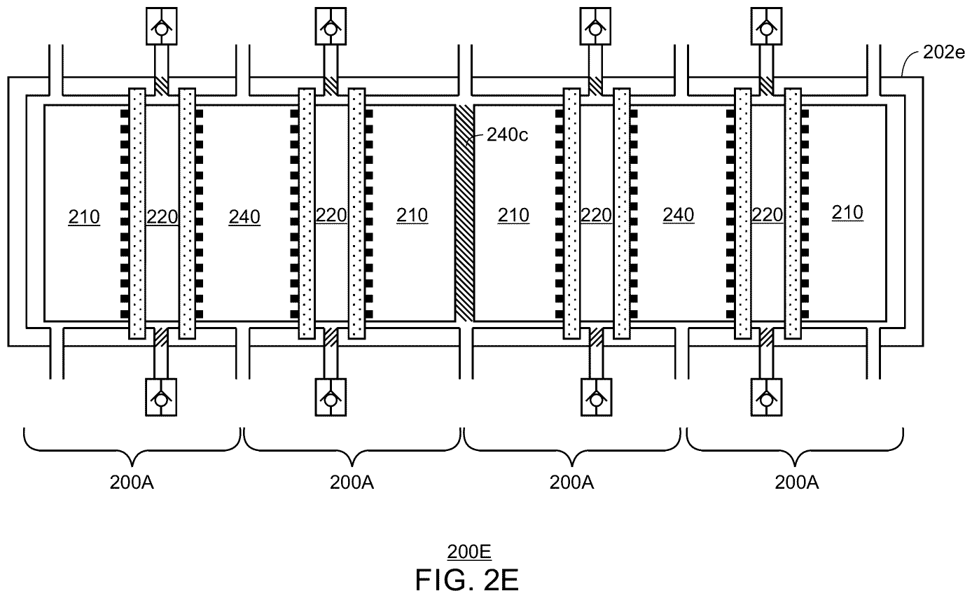

FIGS. 1B and 1C are schematic diagrams of various components of the electrochemical cell 100. FIG. 1B illustrates components housed within the housing 102 of the electrochemical cell 100, while FIG. 1C illustrates components that interact with a contacting boundary formed within the housing 102 of the electrochemical cell 100. The contacting layer 108 can include multiple layers with various combinations of composite force density, composite density, thickness, pore sizes, surface roughness, electrochemical stability, and mechanical strength. In some implementations, layer(s) having more composite force density face towards (or exposed to) the first compartment 110 (gas), while layer(s) having less composite force density face towards the second compartment 120 (fluid, which can include gas, liquid, or both). This configuration can facilitate preferential flow of electrolyte from material having less composite force density into material having more composite force density. Such configuration can allow the fluid 103a to progressively fill various layers of the contacting layer 108 as is transferred from the second compartment 120. In some implementations, as shown in FIG. 1B, a second gas 205a can permeate into the second compartment 120. An example in which the second gas 205a can permeate into the second compartment 120 is shown in FIG. 2A and described in more detail later.

In some cases, it can be beneficial for the contacting layer 108 to have a multilayer structure, in which the layer that is facing the first compartment 110 can be used to provide a high contact area amongst the electrolyte, first electrode 104, and the gas 101a, while the layer that is facing the second compartment 120 and/or adjacent layer that is located closer to the second compartment 120 has more high composite force density for restricting flow of the gas 101a into the second compartment 120. Any additional layers facing the second compartment 120 can impart mechanical strength and rigidity to the contacting layer 108 as well as maintain sufficient volume of the fluid 103a for operation, especially in cases where a substantial amount of gas is present in fluid 103a.

Material having small pore size and large number of attractive intermolecular force groups in contact with the fluid 103a can result in restricting flow of the gas 101a. In some implementations, the material in contact with the fluid 103a and restricting flow of the gas 101a can define pores having an average diameter in a range from about 5 nanometers to about 100 nanometers and can have an average porosity in a range from about 30% to about 50%. The differential pressure between the gas 101a and the fluid 103a required for the gas 101a to flow through in this case may be independent of material thickness. Using a thin layer in such cases can allow for combination of low resistance liquid flow, high ion conductivity, and diffusion through the material with the hermetic seal between the first compartment 110 and the second compartment 120 at various differential pressures between the gas 101a and the fluid 103a.

By increasing composite force density of the contacting layer 108, it can be possible to increase the ability of the layer 108 to retain the fluid 103a within the structure of the layer 108, thereby increasing allowable differential pressures between the gas 101a and the fluid 103a without having the gas 101a and the fluid 103a intermixing with each other. In cases where the composite force density of the contacting layer 108 is very low, a combination of attractive forces may not be sufficient to maintain the required differential pressure between the gas 101a and the fluid 103a. Composite force density can be quantified as the ability of a material to retain a portion of fluid under pressure. A material having a low composite force density can, for example, retain fluid at pressures equal to or less than about 100 pascals (Pa), less than about 500 Pa, or less than about 1 kPa. A material having a high composite force density can, for example, retain fluid at pressures greater than about 10 kPa, greater than about 50 kPa, or greater than about 100 kPa.

In cases where the contacting layer 108 has a very high composite density, the contacting layer 108 may have mechanical properties that are comparable to hard, plastic-like materials. Such property may affect in various ways how the contacting boundary behaves. High composite density, in some cases, can increase resistance of the contacting layer 108 to mass transfer, and is thus undesirable for a variety of processes where mass transfer is desired. On the other hand, in cases where composite density is very low, the mechanical strength of the contacting layer 108 may not be sufficient to maintain structural integrity.

An optimum composite force density and composite density can be determined for each implementation of the cell 100 by taking into account requirements for both mechanical properties and mass transfer properties. Composite density of the contacting layer 108 can be measured, for example, by weighing the contacting layer 108 in air and weighing the contacting layer 108 while the contacting layer 108 is immersed in water, taking into account the difference in water. In some implementations, the composite density of the contacting layer 108 is in a range about 0.1% to about 99.9%, from about 1% to about 99%, from about 10% to about 75%, or from about 20% to about 50%. Composite force density can be quantified as the ability of a material to retain a portion of liquid by measuring the highest absorbency under a static load or pressure. Selection of the materials that make up the contacting layer 108 can be carried out to meet desired physical characteristics, such as high durability and stability in the expected operational environment (e.g., operating pressure and temperature) and during storage.

A contacting boundary is formed between the first compartment 110 (gas portion) and the contacting layer 108, which is shown in FIG. 1C along with the first electrode 104, the hydrophobic additive 114, and the fluid 103a. The contacting layer 108 can include a composite microporous layer (CML) 118 and a composite support layer (CSL) 119. The CML 118 includes a porous material 118a in contact with contacting additive 118c that form open channels 118b. The porous material 118a can be, for example, a substrate. In some cases, the contacting additive 118c covers only a portion (not all) of an outer surface of the porous material 118a. That is, in some cases, at least a portion of the outer surface of the porous material 118a is exposed and left uncovered by the contacting additive 118c. In some implementations, the thickness of the CML 118 is not uniform across a dimension (e.g., length or width) of the CML 118, which can provide an uneven external surface of the CML 118. Having an uneven external surface can increase the contacting surface area amongst the gas 101a, the electrode 104, and the fluid 103a across the contacting boundary, which can improve mass transfer. In some implementations, the thickness of the CML 118 is uniform across a dimension (e.g., length of width) of the CML 118.

During typical operation, open channels 118b are filled with the fluid 103a forming the hermetic seal between the first compartment 110 (gas portion) and the second compartment 120 (liquid portion) across the CML 118. This enables formation of a solid-like structure that can maintain phase separation at various differential pressures between the gas 101a and the fluid 103a.

The CML 118 can be made of a material selected from the group of nonwoven fibers (e.g., cotton, nylon, polyesters, and glass), polymer films (e.g., polyethylene, polypropylene, poly (tetrafluoroethylene), and polyvinyl chloride), ceramic, or any combinations of these. It can be advantageous, in some implementations, for the average thickness of the CML 118 to be in a range from about 5 micrometers (μm) to about 25 μm. It can be advantageous, in some implementations, for an average pore size of the CML 118 to be in a range from about 5 nanometers (nm) to about 100 nm. It can be advantageous, in some implementations, for an average porosity of the CML 118 to be in a range from about 30% to about 50%. In some implementations, the composite density of the CML 118 is in a range from about 0.1% to about 99.9%, from about 1% to about 99%, from about 10% to about 75%, or from about 20% to about 50%.

The CSL 119 can be made of a material selected from the group of felt, fabric, netting, mesh, plastic, metal, glass, ceramic, carbon fiber, or any combinations of these to enhance the functionalities of the CML 118. For instance, the CSL 119 can be arranged in contact with the CML 118 for additional structural support and/or strength. It can be advantageous, in some implementations, for the average thickness of the CSL 119 to be in a range from about 50 μm to about 250 μm. It can be advantageous, in some implementations, for the average pore size of the CSL 119 to be in a range from about 5 μm to about 50 μm. It can be advantageous, in some implementations, for the average porosity of the CSL 119 to be in a range from about 30% to about 50%. The CSL 119 can include a second contacting additive 119a. In some implementations, the second contacting additive 119a is the same as the contacting additive 118c of the CML 118. In some implementations, the second contacting additive 119a of the CSL 119 is different from the contacting additive 118c of the CML 118. In the case a second gas 205a is introduced, the cell 100 can include a third contacting additive 218, which is discussed in more detail later.

The contacting layer 108 is configured to, by its structure and components, substantially equalize and maintain the pressure of the fluid 103a permeating throughout the contacting layer 108 across a specified dimension of the contacting layer 108. For example, the contacting layer 108 is configured to substantially equalize and maintain the pressure of the fluid 103a permeating throughout the contacting layer 108 across a height difference exceeding 200 millimeters (mm), such as greater than 250 mm or greater than 500 mm, as well as maintain the fluid 103a within its structure in the presence of the gas 101a. This is accomplished using surface groups and contacting additives 118c, 119a that exhibit attractive intermolecular forces with the fluid 103a. Examples of such forces include and result from, but are not limited to, ion-induced dipole forces, ion-dipole forces, hydrogen bonding, van der Waals forces, adhesion, cohesion, and surface tension.

The contacting additives 118c and 119a can be in contact with the CML 118 and the CSL 119 in various manners. In one example, the contacting additive (118c and/or 119a) can, to a certain extent, fill the pores present in the CML 118 and the CSL 119. It is possible that individual pieces of contacting additive (118c and/or 119a) may not be interconnected and not fully cover the external surface of the porous material 118a. As such, there may be portion(s) of the substrate 118a in direct contact with the gas 101a and portion(s) of the substrate 118a in direct contact with the fluid 103a. In another example, the contacting additive (118c and/or 119a) can form a thin layer at the external surface of the substrate 118a. In another example, the contacting additive (118c and/or 119a) can fully fill the pores of the substrate 118a while individual pieces of the contacting additive (118c and/or 119a) may not be interconnected and not fully cover the external surface of the substrate 118a. In another example, the contacting additive (118c and/or 119a) can fully fill the pores of the substrate 118a and fully cover the external surface of the substrate 118a. In certain instances, it can be beneficial for the contacting additive 118c to fully cover the external surface of the substrate 118a on the side of the first compartment 110 that is in contact with the gas 101a and electrode 104.

It is appreciated that portion(s) of the substrate 118a that is not covered with contacting additive (e.g., 118c) on one or both sides may offer several unique advantages during manufacturing and storage of components, assembly, and operation of the electrochemical cell 100. One example includes formation of channels for the circulation of the liquid 103a and the gas 101a. Another example includes the role of the substrate 118a in interconnecting components present in the electrochemical cell 100 as well as formation of the hermetic seal and the housing 102 that prevents flows between the liquid 103a and the gas 101a. Such advantages can be apparent to a person skilled in the relevant art.

The contacting layer 108 includes a non-conductive material that is chemically stable in acidic and/or alkaline medium including at high temperature and oxidizing environment. Liquid-filled contacting layer 108 can be impermeable to gas flow unless sufficient external gas pressure is applied. In some implementations, the pressure at which the gas 101a is able to pass through the contacting layer 108 is at least than 2 kilopascals (kPa), at least 5 kPa, at least 10 kPa, at least 50 kPa, at least 100 kPa, at least 500 kPa, at least 1,000 kPa, or at least 3,000 kPa. The contacting layer 108 can operate effectively across a broad range of liquid types (e.g., acidic electrolyte, basic electrolyte, electrolyte containing oxidizing agents such as hypoghloride, hydrogen peroxide, and/or chlorine, and in some cases, organic solvents such as naphtha or mineral oil) and chemical activities over a long time period (e.g., more than 1,000 hours, more than 5,000 hours, more than 10,000 hours, more than 50,000 hours, more than 100,000 hours, or more than 200,000 hours), with sufficient durability and strength.

The electrochemical cell 100 can include a single or multiple contacting layers 108. The contacting layer 108 can include tubes (solid or hollow) to further increase the contact surface area between the gas 101a of the first compartment 110 and the liquid 103a of second compartment 120. In some cases, at least one of a length, width, or diameter of the contacting layer 108 is determined based on flow rates of the gas 101a and/or liquid 103a, the amount of mass transfer required, the operational lifetime of the electrochemical cell 100, or any combinations of these.

The contacting layer 108 can be flat (e.g., have an even surface) or can have a rough surface by including fibers, balls, ridges, or any combinations of these. Increasing the contact surface area of the contacting layer 108 by including such components to provide an uneven surface can improve the overall performance of the electrochemical cell 100.

In some implementations, the thickness of the contacting layer 108 is not uniform across a dimension (e.g., length or width) of the contacting layer 108, which can provide an uneven external surface of the contacting layer 108. Having an uneven external surface can increase the contacting surface area amongst the gas 101a, the electrode 104, and the fluid 103a across the contacting boundary, which can improve mass transfer. In some implementations, the thickness of the contacting layer 108 is uniform across a dimension (e.g., length of width) of the contacting layer 108. The thickness of the contacting layer 108 may be determined based on the specific requirements, for instance, mechanical properties, system assembly, mass transfer rate, or any combinations of these. A thinner contacting layer 108 can generally exhibit less resistance to mass transfer rate compared to a thicker contacting layer 108. In some cases, however, it can be possible for the contacting layer 108 to be in the form of thin films with sufficiently strong and/or stable mechanical properties but poor mass transfer rates (e.g., very dense, highly interlinked polymer layers). In other cases, a thicker contacting layer 108 may have poor mechanical properties and high rates of mass transfer (e.g., low interconnection and low density of polymer chains or various additives present that promote fast rate of mass transfer, for example, through channel diffusion).

Thus, an electrochemical cell 100 is provided, where the contacting layer 108 acts as a physical barrier preventing the flow of the gas 101a into the second compartment 120 while still allowing for contact area between the gas 101a and the fluid 103a. Furthermore, contact area amongst the gas 101a, the fluid 103a, and the electrode 104 is defined by the structures and shapes of the contacting layer 108, electrode 104, and hydrophobic additive 114. As such, it is possible to create very high contact surface area per unit of volume, thereby substantially increasing the contact time and kinetics between the gas 101a and fluid 103a in contact with electrode 104. Accordingly, the electrochemical cell 100 may be relatively small in size in comparison to conventional electrochemical cells but still be able to provide a surprisingly high contact surface area amongst the gas 101a, fluid 103a, and electrode 104.

It can be advantageous to operate the electrochemical cell 100 in such a way that the first gas 101a has a pressure that is equal to or greater than the pressure of the fluid 103a at the inlet 122a and outlet 122b of the second compartment 120. Such configuration enables formation of high contact area between the electrolyte of the fluid 103a, electrode 104, and gas 101a and, in some cases, promote transfer of excess liquid products formed at the contacting boundary into the second compartment 120.

The contacting layer 108 can be configured to improve the mass transfer rate of a selected component while reducing the mass transfer rate of another component. In this way, mass transfer process within the electrochemical cell 100 can have specific selectivity, if needed. For example, sulfonic acid groups can enhance proton conductivity. As another example, quaternary ammonium groups can promote anion exchange. As another example, sulfonate and carboxylate groups can facilitate selective transport of positively charged ions. As another example, phosphate groups can enhance transport of multivalent ions. As another example, hydroxyl, amine, and ester groups can hinder transfer of particular ions. The specific role of each functional group can depend on the specific application. Selectivity can be adjusted by including functional groups, for example, by direct polymerization, post-polymerization modification, functional initiators, or group transformation.

The second compartment 120 can include a composite interlayer 126 that is porous for enabling liquid 103a flow across and along second compartment 120 so that the fluid 103a is in fluid connection with contacting layer 108, inlet port 122a, and outlet port 122b. The second compartment 120 can include a second electrode 106 and a catalyst in contact with the electrode 106 to catalyze electrochemical reactions. The second electrode 106 can be in contact with a redox reactive material. Some examples of solid form redox reactive materials include redox reactive materials including zinc, aluminum, magnesium, nickel, copper, manganese, lithium, sodium, sulfur, or any combinations of these. Some examples of liquid form redox reactive materials include redox reactive materials including hydroxyphthalimide, (2,2,6,6-tetramethylpiperidine-1-yl)oxyl quinone derivatives, bromine, iodine, vanadium, aluminum, iron, polyoxymethylenes, chromium, cerium, manganese, titanium, or any combinations of these.

The use of an organic solvent may help to facilitate the distribution of contacting additive (e.g., 118c or 119a) throughout the substrate. This is because the use of an organic solvent may sometimes reduce difficulties in wetting and/or saturating the substrate. A variety of organic solvents may be used. Exemplary organic solvents can include, without limitation, an alkane, a ketone, an ester, an ether, an alcohol, and the like, as well as a combination of these solvents. For example, exemplary organic solvents can include heptane, ethyl acetate, butyl acetate, isoamyl acetate, dioctyl adipate, acetone, methyl ethyl ketone, methyl isobutyl ketone, isopropanol, diethyl ether, mineral spirits, petroleum distillate, and any combinations of these. The choice of an organic solvent or solvents for use can be affected by a variety of factors including, without limitation, solubility of the polymer of the contacting additive, boiling point of the solvent, molecular weight of the solvent, polarity of the solvent or solvent combination, and the like.

In some cases, the material of the contacting additive (e.g., 118c or 119a) is in the form of a stabilized water-miscible dispersion of polymeric solids. In this case, the material of the contacting additive (e.g., 118c or 119a) can also contain a relatively small amount of acetone and ethylene glycol or other water-miscible solvents and surfactants that were used in the polymerization reaction when the material was made. Optionally, the dispersion of the material of the contacting additive (e.g., 118c or 119a) is stabilized with a stabilizing agent, such as, but not limited to, deionized and/or demineralized water. The stabilizing agent reduces the propensity of the material of the contacting agent (e.g., 118c or 119a) from settling out and agglomerating to a size which cannot enter a pore in the substrate. Although the composition of the material of the contacting additive (e.g., 118c or 119a) can include any suitable amount of stabilizing agent, in some cases the composition of the contacting additive (e.g., 118c or 119a) includes an amount of stabilizing agent, for example, in the range from about 5 weight percent (wt. %) to about 50 wt. % or about 15 wt. % to about 25 wt. %.

Contacting additives (e.g., 118c or 119a) can be derived from polymerization of a variety of monomers and/or oligomers known to produce the desired backbone. A monomer or oligomer can optionally be copolymerized with another monomers or oligomer, examples including formation of copolymer, alternating, random or block-wise polymer. Examples of monomers or oligomers may include a (C₁₋₃₂) hydrocarbon moiety, in particular a (C₁₋₃₂) alkyl moiety.

In one example, an alkyl moiety is present, in particular —CH₃, —CH₂—CH₃, —CH₂—CH₂—CH₃. In another example, a (C₁₋₁₂) alkylene moiety is present, in particular —CH₂—, —CH₂—CH₂—, —CH₂—CH₂—CH₂—. Exemplary monomer or oligomer units can include, for example, (C₁₋₁₆) alkylacrylate, (C₁₋₁₆) alkyl methacrylate, (C₁₋₁₂) alkylmaleic acid ester, (C₁₋₁₂) alkyl (C₆₋₁₂) aryl urethane oligomer, (C₁₋₁₂) alkyl allyl urethane oligomer, (C₁₋₁₂) alkyl urethaneacrylate oligomer. A monomer or oligomer may optionally be polymerized with an additional fluorinated monomer or oligomer including for example fluoro (C₁₋₁₆) alkylacrylate and fluoro (C₁₋₁₆) alkyl methacrylate.

Specific exemplary classes of oleophobic polymers include, without limitation, an apolar perfluoroalkylpolyether having —CF₃, —CF₂CF₃, and —CF₂CF₂CF₃ moiety (PFPE), a mixture of apolar PFPE with polar monofunctional PFPE, polar water-insoluble PFPE with phosphate, silane, or amide end groups, a mixture of apolar PFPE with fluorinated or perfluorinated (C₁₋₁₂)alkyl methacrylate polymer or fluorinated or perfluorinated (C₁₋₁₂)alkyl acrylate polymer, and a copolymer comprising a perfluoro(C₁₋₃)alkylether unit, fluorinated or perfluorinated (C₁₋₁₂)alkyl methacrylate unit, or fluorinated or perfluorinated (C₁₋₁₂)alkyl acrylate unit.

Other examples of monomers for creating a water-insoluble polymer include, without limitation, a (meth) acrylic ester, vinyl acetate, a maleic acid ester, isooctyl (meth) acrylate, 2-ethylhexyl (meth) acrylate, butyl (meth) acrylate, vinyl acetate, alone or a copolymer of hydrophobic monomers such as dioctyl maleate, ethylene, propylene, butylene, methyl (meth) acrylate, ethyl (meth) acrylate.

One specific form that the oleophobic polymers are commercially available is emulsions. Exemplary emulsions can include, without limitation, those based on a copolymer of siloxane and (C₁₋₁₂)alkyl-substituted acrylate or methacrylate, one type of unit containing at least alkyl vinyl ether, emulsions based on (C₁₋₁₂)alkyl-substituted polyacrylate and methacrylate, and the like.

Non-limiting examples of monomers may further include acrylamide, N-methylacrylamide, N-ethylacrylamide, cyclopropylacrylamide, N-isopropylacrylamide, methacrylamide, N-methylmethacrylamide, cyclopropylmethacrylamide, N-isopropylmethacrylamide, dimethylacrylamide, N,N-dimethylaminopropylacrylamide, N-methyl-N-ethylacrylamide, N-methyl-N-isopropylacrylamide, N-methyl-N-ethylacrylamide, N-methyl-N-isopropylacrylamide, N-methyl-N-n-propylacrylamide, N,N-diethylacrylamide, N-acryloylpyrrolidine, N-acryloylpiperidine, N-acryloylmethylhomopiperidine, N-acryloylmethylpiperidine, and N-acryloylmethylpiperidine.

More specific examples of the polymer include: poly(N-alkyl(meth)acrylamide) such as poly(N-isopropyl(meth)acrylamide), poly(N-n-propyl(meth)acrylamide), poly(N-methyl(meth)acrylamide), poly(N-ethyl(meth)acrylamide), poly(N-n-butyl(meth)acrylamide), poly(N-isobutyl(meth)acrylamide), and poly(N-t-butyl(meth)acrylamide); poly(N-vinylalkylamide) such as poly(N-vinylisopropylamide), poly(N-vinyl n-propylamide), poly(N-vinyl n-butylamide), poly(N-vinylisobutylamide), and poly(N-vinyl-t-butylamide); poly(N-vinylpyrrolidone); poly(2-alkyl-2-oxazoline) such as poly(2-ethyl-2-oxazoline), poly(2-isopropyl-2-oxazoline), and poly(2-n-propyl-2-oxazoline); polyvinyl alkyl ethers such as polyvinyl methyl ether and polyvinyl ethyl ether; a copolymer of polyethylene oxide and polypropylene oxide; poly(oxyethylene vinyl ether); cellulose derivatives such as methyl cellulose, ethyl cellulose, hydroxypropyl cellulose, and hydroxypropyl methyl cellulose; and copolymers of the above polymers. Other examples include N-alkyl(meth)acrylamides such as N-isopropyl(meth)acrylamide, N-n-propyl(meth)acrylamide, N-methyl(meth)acrylamide, N-ethyl(meth)acrylamide, N-n-butyl(meth)acrylamide, N-isobutyl(meth)acrylamide, and N-t-butyl(meth)acrylamide; N-vinylalkylamides such as N-vinylisopropylamide, N-vinyl n-propylamide, N-vinyl n-butylamide, N-vinylisobutylamide, and N-vinyl-t-butylamide; vinyl alkyl ethers such as vinyl methyl ether and vinyl ethyl ether; ethylene oxide and propylene oxide; and 2-alkyl-2-oxazolines such as 2-ethyl-2-oxazoline, 2-isopropyl-2-oxazoline, and 2-n-propyl-2-oxazoline.

The contacting additive (e.g., 118c or 119a) may include cross-linked polymer with chains, either branched or linear, that can form covalent or ionic bonds between the polymer molecules. Cross-linked polymers form bonds that are much stronger than the intermolecular forces that attract other polymer chains, resulting in a stronger and more stable material. An example of such crossed-linked polymers is vulcanized natural rubber, which means it is heated so the sulfur molecules in the rubber polymer chains form covalent bonds with one another. Cross-linked polymers can be produced by other techniques, such as free-radical polymerization, condensation reactions, small molecules cross linking and radiation.

Free radical polymerization can require the use of an initiator and heat. Chemically cross-linked polymers can be produced using techniques such as suspension, emulsion, and dispersion polymerization techniques.

Cross-linking through condensation reactions takes place in the presence of heat, catalyst, or both. Polymer with diamine compounds can be produced by condensation reactions among the carbonyl group (>C═O) with amine group (—NH). These reactions may be used to improve thermal steadiness and texture behavior by means of normal chemical action by the use of aliphatic and aromatic diamines in several ratios as cross-linking agents.

Some small-molecules considered as a cross-linker and used potentially to obtain cross-linked polymer such as formaldehyde, glutaraldehyde, potassium dichromate, osmium tetroxide, and potassium permanganate, other than the multifunctional (bi, tri, or tetra) cross-linking agents.

During crosslinking via free radical polymerization, through condensation reactions and with the use of small molecules, degree of cross-linking is controlled by an amount of cross-linker, reaction time, temperature, stirring speed, and an initiator/catalyst (type and concentration).

Cross-linking can occur using radiation treatment such as the gamma exposure, proton, electron, UV, implantation and ion irradiation. Examples include rubber tires, wires, cross-linked cables, development of cross-linked silicon carbide fibers and polymer recycling. High energy electromagnetic irradiation can crosslink water-soluble monomer or polymer chain ends without the addition of a crosslinker. During irradiation, using a gamma or electron beam, solutions of monomers are polymerized to form a contacting agent. This process has an advantage over other crosslinking methods since it can be performed at room temperature and in physiological pH without using toxic and hard to remove crosslinking agents.

During crosslinking via radiation treatment, the degree of cross-linking is controlled by high-energy ionizing radiation, gamma, x-ray or other and their radiation dose. Cross-linking processes have been widely utilized to overcome the significant week points in polymeric materials, such as rigidity, mechanical strength, strain modulus, stiffness, thermal stability as well as morphological behaviors. A cross-linked product is significantly affected by the type of cross-linker and its concentration. Properties like thermal degradation, glass transition, particle size, pore size, pore volume, surface area, and swelling are totally changed after cross-linking occurred. Important cross-linker types are hydrophilic, hydrophobic, rigid, or flexible.

Monomers that can be used as cross-linkers or cross-linking agents include, for example, N,N′-Bisacrylamide, N,N′-BIS(ACRYLOYL)-CYSTAMINE, ethylenediamine, 1,3-propanediamine, 1,3-propanedithiol, dithiothreitol, dithioerythritol, 1,5-pentanediamine, hexamethylenediamine, diethylenetriamine, triethylenetetramine, propylenediamine, di(aminomethyl)ether, 1,8-diamino-4-(aminomethyl)octane, xylylenediamine, hydroquinone, bisphenol A, bisphenol sulfone, 1,4-butanedisulfinic acid, benzenedisulfinic acid, thioethanolamine, p-aminothiophenol, and butylenediamine, ethyleneglycol dimethacrylate, trimethylolpropane triacrylate, hexamethyleneglycol dimethacrylate, glycerol α,α′-diallylether, n-methylol acrylamide, vinylbenzene chloride, allyl chloride, gloxal, polyvinyl alcohol, polyethyleneimine, 1-vinylimidazole, hexadiene, tetraethylene glycol dimethacrylate, divinyl benzene, 1,6-diaminohexane, p-phenylenediamine, ethylene glycoldi(meth)acrylate, propylene glycoldi(meth)acrylate, N,N′-methylenebis(meth)acrylamide, tolylene diisocyanate, divinylbenzene, and polyethylene glycoldi(meth)acrylate; glutaraldehyde; polyvalent alcohol; polyvalent amine; polyvalent carboxylic acid; and a metal ion such as calcium ion and zinc ion; and combinations thereof. These crosslinking agents can be used alone, or two or more kinds of these crosslinking agents can be used in combination.

In one example, introducing dynamic bonds such as hydrogen bonds, metal-ligand coordination, ionic bonds and associations may be used to realize a self-healing property of the contacting additive. Without the restriction of covalent cross-linking, the chains in an ionic supramolecular network have good flexibility and mobility. The ability of the ionic cross-links to easily reconstruct and rearrange facilitates the self-healing behavior of the contacting additive, thereby enabling a fully cut sample to re-join and retain its original properties after a suitable self-healing process at ambient temperature.

For example, the contacting additive may balance mechanical properties such as tensile strength, elongation at break and the ability to self-repair. The toughness and stretch ability arise from the reversible cross-linking interactions between the polymer chains that help dissipate energy through stress (deformation) triggered dynamic processes.

The preparation process of the contacting additive can include any suitable method for forming three-dimensional networks of polymers or fibers. Exemplary techniques may include applying the composition of the contacting additive on a substrate, mold or matrix in a liquid form, e.g., a melt, or solution, or latex dispersion of the composition material. Exemplary methods for applying the composition material in the liquid form may include, without limitation, dipping, painting, spraying, roller-coating, brushing, and the like, over the surface of the substrate, mold or matrix. Regardless of the technique, the application can be carried out until internal surfaces of the substrate, mold or matrix are coated with composition of contacting additive. Formation of the contacting additive can be achieved by varying the concentration, solids content of the solution or dispersion, and/or by varying the application temperature, or pressure.

Exemplary polymerization techniques include radical, addition, condensation as well as Gamma and Electron Beam Polymerization. Examples of addition (also known as chain-growth) polymerization include free-radical polymerization, controlled-radical polymerization as well as anionic and cationic polymerization. Free radical polymerization consists of initiation, propagation, and termination. After initiation, a free radical active site is generated which adds monomers in a chain link-like fashion. Controlled living radical polymerizations offer the benefits of longer growing chain life with examples including atomic transfer radical polymerization (ATRP) and Reversible addition fragmentation transfer (RAFT) polymerization.

Similar to addition polymerization, during condensation polymerization functional groups react in a stepwise manner to form a covalently linked gel network with examples including polyurethanes, polyesters, or nylon polymers.

Gamma and electron beam polymerizations parallel the initiation, propagation, and termination model held in free radical polymerization. In this process, hydroxyl radicals are formed and initiate free radical polymerization among the vinyl monomers which propagate in a rapid chain addition fashion.

Exemplary initiators/catalysts for radical polymerization are those that are water soluble and those that can be substantially homogeneously dispersed in water. Non-limiting examples include a water soluble peroxide, such as potassium peroxidisulfate and ammonium peroxidisulfate; water soluble azo compounds non-limiting examples of which include azo-bis-isobutyrate imidazoline hydrochloride, 2,2′-azobis(2-methylpropionamidine)-dihydrochloride, and 4,4′-Azobis(4-cyanovaleric acid), as well as various other water soluble radical initiators having poly(ethylene oxide) chains.

Examples of the photopolymerization initiators include alpha-hydroxy ketones, alpha-amino ketone, benzyl methyl ketal, bis acyl phosphine oxide, metallocene, and the like. More specifically, 2-hydroxy-2-methyl-1-phenyl-propane-1-one, 1-hydroxy-cyclohexyl phenyl-ketone, 1-[4-(2-hydroxyethoxy)-phenyl]-2-hydroxy-2-methyl-propan-1-one, 2-methyl-1-[(methylthio) phenyl]-2-morpholinopropan-1-one, 2-benzyl-2-dimethylamino-1-(4-morpholinophenyl), 2-ahydroxy-1-{4-[4-(2-hydroxy-2-methyl-propionyl)-benzyl] phenyl}-2-methyl-propan-1-one. These initiators may be used independently or in combinations.

Non-limiting examples of catalysts suitable for use herein include N,N′,N′-tetramethylethylenediamine and β-Dimethylaminopropionitrile. The polymerization temperature is optionally set to a range of 0° C. to 100° C. in conformity with the selected initiator and catalyst. The polymerization time, also, will vary with the type of catalyst and initiator and polymerization conditions such as the amount of polymerizing solution (concentration), and the polymerization time periods are within a few seconds to hours. An exemplary method of carrying out the polymerization is to make an aqueous solution of the monomer, add an initiator to the solution, and then add the catalyst. In another example the contacting additive (e.g., 118c or 119a) can be produced through the use or functionalization of existing polymers (natural or artificial).

The fluid 103a used in the electrochemical cell 100 exhibits sufficient fluidity to allow the flow at operational temperature and pressure. The electrochemical cell 100 allows for the use of either polar or non-polar liquids in addition to high ionic strength liquids (e.g. an ionic liquid or a mixture thereof where there can be negligible amount of solvent present). Variation in the chemical composition of the fluid 103a in some cases may provide process selectivity. Without intending to be limited by theory, the electrochemical cell 100 not only allows a wide range of solvents to be used, but also has sufficient strength and/or durability to withstand harsh conditions imparted by the fluid 103a used, such as high or very high acidity, alkalinity or extreme temperatures. As such, and as will be further described below, the electrochemical cell 100 allows for use of a variety of solvents.

Specifically, the fluid 103a may be selected from the group of water, chlorine, hydrogen peroxide, alkali metal chloride, alkali metal hydroxide, carbonate and bicarbonate, an aqueous solution of an alkaline or alkaline earth hydroxide, an alkaline earth oxide, an alkaline or alkaline earth carbonate, an aqueous solution selected from the group of water soluble oxidizing salts, water soluble halide containing salts, NaClO₂, NaClO₃, H₂O₂, KMnO₄, Ca(OCl)₂, and any combinations of these.

The fluid 103a can include an ionic liquid. The low vapor pressure of an ionic liquid provides a simple mechanism for extraction of liquid products, such as distillation, evacuation, or extraction with a supercritical fluid. Such a supercritical fluid may be supercritical carbon dioxide. In some implementations, the fluid 103a includes components that selectively solubilizes one or more desired gaseous components of the gas 101a.

It is appreciated that the anion component of an ionic liquid may impart acidic, basic, or neutral properties to the ionic liquid. As such, it is beneficial to consider such properties when choosing an ionic liquid for the liquid, such that the capacity or selectivity of the gas absorption may be enhanced. For example, an ionic liquid exhibiting more basic character may be better suited for CO₂ absorption rather than for ammonia absorption. It is also appreciated that a dry ionic liquid may exhibit greater overall capacity for absorbing one or more gaseous components. This is because the presence of water in an ionic liquid may reduce its capacity for dissolving certain gaseous components. In addition, the presence of water may decrease the solubility of certain gas components in the ionic liquid, especially where those gaseous components are hydrophobic. It is further appreciated that a dry ionic liquid may exhibit differential selectivity between various gaseous components when compared to an ionic liquid containing a measurable amount of dissolved water, such as an ionic liquid having been exposed to a humid atmosphere.

Materials and structures of first compartment 110, contacting layer 108, and second compartment 120 should provide sufficient stability towards chemical and mechanical degradation under operating conditions such as temperature, mechanical agitation, various chemicals present in the gas and the liquid, and rate of temperature and pressure changes. In one example, the materials can include a linear polymer that is simply a chain in which all the carbon-carbon bonds exist in a single straight line. An example of a linear polymer is polytetrafluoroethene, which is made from tetrafluoroethylene. In another example the material can include a branched polymer where groups of units branch off from the long polymer chain. These branches are known as side chains and can also be very long groups of repeating structures. Branching may result from the formation of carbon-carbon or various other types of covalent bonds. Branching by ester and amide bonds is typically achieved by a condensation reaction, producing one molecule of water (or HCl) for each bond formed. Example of branched polymers include low density polyethylene. In another example the material can contain several interpenetrating networks, each of which may be a combination of any of the above-mentioned types of polymers. It may be beneficial to use interpenetrating networks where individual networks provide added functionality to the whole system. For example, one of the networks can provide the ability to retain liquid while another imparts the required mechanical strength and durability or provides important characteristic for integration with other components (e.g. to achieve sealing between elements of electrochemical cell 100) as well as overall device assembly. In another example, one of the networks can provide the ability to retain liquid while the other is responsive to an external stimulus including temperature, electric or magnetic field, light, pressure, and sound, pH, solvent composition, ionic strength, and molecular species.

Materials and structures of first compartment 110, contacting layer 108, and second compartment 120 may be functionalized through various treatments and the use of contacting additives to reach desired functionality. For instance, acid treatment may be used to introduce —OH and/or —OOH groups by, for example, soaking material into nitric acid (either concentrated and/or hot). Another example of such treatments is oxidization. Various oxidizers may be used, including, for example, hydrogen peroxide, sodium hypochlorite, potassium permanganate acidified with concentrated HCl, etc. In a further example, the surface may be heat treated in the absence of air with ammonia gas to introduce —NH₂ groups to increase hydrophilicity. In a still further example, air or oxygen (O₂) gas plasma may be used to produce a more hydrophilic surface via the addition of surface C—O and C═O groups. It will also increase surface wettability. Water vapor (H₂O) may also be used to render the surface more hydrophilic and may be especially advantageous for polymers. Alternatively, an argon plasma may be preferred for surface activation to minimize further oxidation of the surface (e.g., metals). Other alternatives may include UV-ozone treatment of the surface. In another example the surface may be coated with a material that provides one or more desired characteristics. For example, plasma coating technique may be used where different monomers are used to produce hydrophobic and hydrophilic surfaces. Suppliers include Henniker Plasma, 3 Berkeley Court, Manor Park, Runcorn, WA7 1TQ. In some cases, contacting additives (e.g., 118c or 119a) are laminated to the substrate thermal means, adhesive means and the like.

FIG. 2A is a schematic diagram of an example electrochemical cell 200A. The electrochemical cell 200A is substantially similar to the electrochemical cell 100. For example, the electrochemical cell 200A of FIG. 2A has all the components of the electrochemical cell 100 of FIG. 1, along with some additional components. A first gas 201a, a second gas 205a, and a fluid 203a including an electrolyte can be flowed to the cell 200. Electrical power can be supplied to the cell 200. The cell 200 utilizes the supplied electrical power to facilitate a reaction between the gases 201a, 205a and the fluid 203a for producing a desired product. The cell 200 produces a first outlet gas 201b, a second outlet gas 201b, and an outlet fluid 203b. In some implementations, the first outlet gas 201b includes the desired product. In some implementations, the second outlet gas 201b includes the desired product. In some implementations, the outlet fluid 203b includes the desired product. In some implementations, the outlet gas 201b includes a first desired product, and the outlet fluid 203b includes a second desired product. In some implementations, the first outlet gas 201b includes a first desired product, and the second outlet gas 201b includes a second desired product. In some implementations, the outlet fluid 201b includes a first desired product, and the second outlet gas 201b includes a second desired product. In some implementations, the first outlet gas 201b includes a first desired product, the second outlet gas 201b includes a second desired product, and the outlet fluid 203b includes a third desired product. As an example, a desired product as a liquid phase can be produced during operation of the cell 100, condensed from the gas 201a, condensed from the second gas 205a, or any combinations of these. The desired product as a liquid phase can mix with the fluid 203a as the outlet fluid 203b. As another example, reactant(s) in the fluid 203a can be consumed during operation of the cell 200, evaporated and mixed with the gas 201a as the outlet gas 201b, evaporated and mixed with the second gas 205a as the second outlet gas 201b, or any combinations of these.

The housing 202 of the electrochemical cell 200A defines a first compartment 210, a second compartment 220, and a third compartment 230. The housing 202 defines a first gas inlet 212a at the first compartment 210. The first gas inlet 212a is configured to receive the gas 201a into the first compartment 210. The housing 202 defines a fluid inlet 222a at the second compartment 220. The fluid inlet 222a is configured to receive a fluid 203a into the second compartment 220. The housing 202 defines a second gas inlet 232a at the third compartment 230. The second gas inlet 232a is configured to receive the second gas 205a into the third compartment 230. A first electrode (not shown) can be disposed within the first compartment 210 or the third compartment 230. A second electrode (not shown) is disposed within the second compartment 220. A first contacting layer 208 is disposed within the housing 202 between the first compartment 210 and the second compartment 220. The contacting layer 208 is configured to hermetically separate (seal) the first compartment 210 from the second compartment 220 while allowing fluid communication amongst the fluid 203a and the gas 201a, and in cases where the first compartment 210 houses the first electrode 204, the first electrode 204 (or in some cases, a catalyst contacting the first electrode). A contacting boundary is formed between the first compartment 210 and the contacting layer 208. A second contacting layer 208′ is disposed within the housing 202 between the third compartment 230 and the second compartment 220. The contacting layer 208′ is configured to hermetically separate (seal) the third compartment 230 from the second compartment 220 while allowing fluid communication amongst the fluid 203a and the second gas 205a, and in cases where the third compartment 230 houses the first electrode, the first electrode (or in some cases, a catalyst contacting the first electrode). A contacting boundary is formed between the third compartment 230 and the contacting layer 208′.

The second compartment 220 is configured to, by its structure and components, substantially equalize and maintain pressure of the fluid 203a throughout its structure across a specified dimension of the second compartment 220. For example, the second compartment 220 is configured to substantially equalize and maintain the pressure of the fluid 203a throughout the second compartment 220 across a height difference in a range from about 200 mm to about 300 mm, from about 250 mm to about 300 mm, or from about 250 mm to about 500 mm, as well as maintain fluid connection of the fluid 203a amongst the contacting layer 208 separating the first compartment 210 and second compartment 220, the second electrode of second compartment 220, and a second implementation of the contacting layer 208′ separating the second compartment 220 and a third compartment 230. Such fluid connection is maintained even in the presence of the second gas 205a in the second compartment 220. This is accomplished using surface groups and a third contacting additive 218 that exhibit attractive intermolecular forces with liquid. Examples of such forces include and result from, but are not limited to, ion induced dipole forces, ion-dipole forces, hydrogen bonding, van der Waals forces, adhesion, cohesion, and surface tension. In some implementations, the third contacting additive 218 is the same as the contacting additive 118c of the CML 118 and/or the second contacting additive 119a of the CSL 119. In some implementations, the third contacting additive 218 is different from the contacting additive 118c of the CML 118 and/or the second contacting additive 119a of the CSL 119.

Although shown in FIG. 2A as having a parallel flow configuration, the cell 200 can, in some implementations, have a counterflow configuration. For example, the fluid inlet 222a and the fluid outlet 222b can be switched (and direction of the check valves reversed), so that the general direction of flow of the gas 201a through the first compartment 210 is opposite of the general direction of flow of the fluid 203a through the second compartment 220, and the general direction of flow of the second gas 205a through the third compartment 230 is opposite of the general direction of flow of the fluid 203a through the second compartment 220.

FIG. 2B is a schematic diagram of an example electrochemical cell system 200B. The electrochemical cell system 200B includes multiple implementations of the electrochemical cell 200A of FIG. 2A. The electrochemical cells 200A of the electrochemical cell system 200B are housed within a common housing 202b. The electrochemical cell system 200B includes a conductive bipolar plate 240 between each pair of neighboring electrochemical cells 200A. The conductive bipolar plate 240 separates neighboring gas compartments of the respective electrochemical cells 200A while also providing an electrical connection between electrodes of the neighboring electrochemical cells 200A. The dotted lines in FIG. 2B represent contacting boundaries formed between the electrode and gas of the gas compartments with the contacting layer and fluid of the liquid compartment. The plate 240 exhibits sufficient electrical conductivity and enables a low resistance connection with the electrodes in compartments 210, 230 (e.g., via welding, soldering, or mechanical connection). The plate 240 exhibits corrosion resistance based on the specific application (e.g., against acids, bases, or oxidizing agents). The plate 240 has compatibility with various components of the system 200B for providing a sufficient seal (e.g., sufficient adhesion with particular sealants and/or adhesives). In some implementations, a surface coating can be applied to the plate 240 to improve electrical conductivity, reduce contact resistance, or enhance contact resistance (e.g., by including conductive polymer(s) or precious metal coating(s) such as gold, platinum, and/or oxide layers). The plate 240 can impart additional mechanical strength to the system 200B for withstanding pressures in the system 200B. In some implementations, the plate 240 defines flow channels (e.g., by stamping, bending, casting, etching, and/or machining) to facilitate distribution of reactants and removal of byproducts, similar to the layer 150. The plate 240 can be made of, for example, metal(s) (e.g., stainless steel, titanium, or aluminum), graphite, a composite material (e.g., carbon fiber-reinforced polymer or metal-polymer composites), or any combinations of these.

FIG. 2C is a schematic diagram of an example electrochemical cell system 200C. The electrochemical cell system 200C includes multiple implementations of the electrochemical cell 200A of FIG. 2A. The electrochemical cells 200A of the electrochemical system 200C are housed within a common housing 202c. The electrochemical cell system 200C includes a separator 240c between each pair of neighboring electrochemical cells 200A. The separator 240c separates neighboring gas compartments of the respective electrochemical cells 200A. In some implementations, the separators 240c are electrically conductive. In some implementations, the separators 240c are not electrically conductive. In some implementations, one or more of the separators 240c are electrically conductive, while a remainder of the separators 240c are not electrically conductive. In the specific example shown in FIG. 2C, all the separators 240c are not electrically conductive.

FIG. 2D is a schematic diagram of an example electrochemical cell system 200D. The electrochemical cell system 200D includes multiple implementations of the electrochemical cell 200A of FIG. 2A. The electrochemical cells 200A of the electrochemical system 200D are housed within a common housing 202d. The electrochemical cell system 200D includes a conductive bipolar plate 240 between neighboring third compartments 230 of the electrochemical cells 200A. The electrochemical cell system 200C includes a separator 240c that is electrically non-conductive between neighboring first compartments 210 of the electrochemical cells 200A. Selection of electrically conductive (conductive bipolar plate 240) and electrically non-conductive separators 240c can depend on various factors, such as the types of gas contained within neighboring gas compartments and locations of electrodes within the gas compartments. For example, in cases where it is advantageous to electrically connect electrodes of neighboring gas compartments, the respective separator 240c between those neighboring gas compartments can be electrically conductive. As another example, in cases where it is not necessarily advantageous to electrically connect neighboring gas compartments (e.g., the neighboring compartments do not house electrodes), an electrically non-conductive separator 240c can be sandwiched between those neighboring gas compartments. In the specific example shown in FIG. 2D, the third compartments 230 of the electrochemical cells 200A house electrodes, so it is advantageous to sandwich the conductive bipolar plate 240 between the third compartments 230 to electrically connect the electrodes in those neighboring third compartments 230.

FIG. 2E is a schematic diagram of an example electrochemical cell system 200E. The electrochemical cell system 200E includes multiple implementations of the electrochemical cell 200A of FIG. 2A. The electrochemical cells 200A of the electrochemical system 200E are housed within a common housing 202e. The electrochemical cell system 200E of FIG. 2E is substantially similar to the electrochemical cell system 200D of FIG. 2D. While the third compartments 230 of neighboring electrochemical cells 200A of system 200D are separated by a conductive bipolar plate 240, the system 200E instead combines the third compartments 230 into a common fourth compartment 240. Further, because the third compartments 230 are combined as the fourth compartment 240 in system 200E, the conductive bipolar plate 240 (not shown) is omitted.

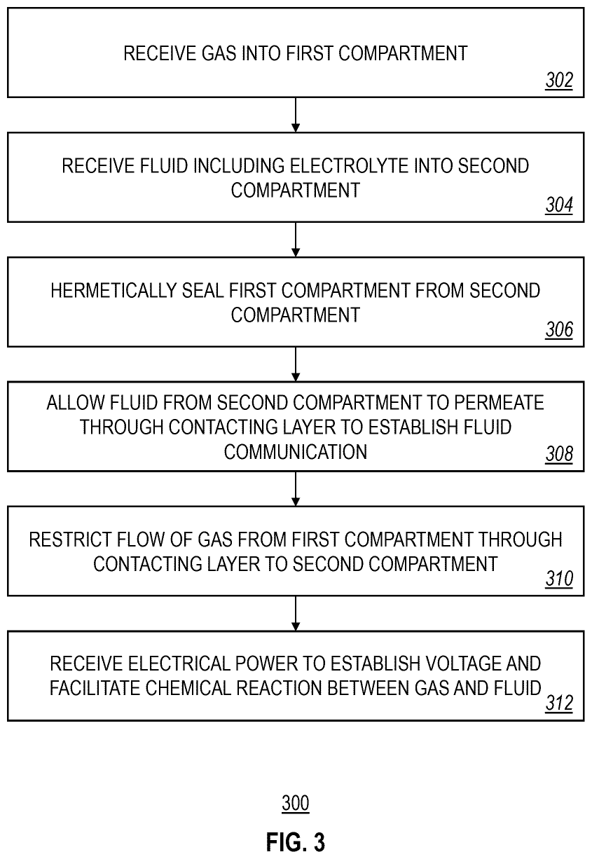

FIG. 3 is a flow chart of an example method 300 of operating an electrochemical cell. Any of the electrochemical cells 100 or 200A or electrochemical cell systems 200B, 200C, 200D, or 200E can, for example, implement method 300. At block 302, a gas (such as the gas 101a) is received into a first compartment (such as the first compartment 110) of an electrochemical cell (such as the electrochemical cell 100). At block 304, a fluid (such as the fluid 103a) that includes an electrolyte is received into a second compartment (such as the second compartment 120) of the electrochemical cell 100. At block 306, a contacting layer (such as the contacting layer 108) of the electrochemical cell 100 hermetically seals the first compartment 110 from the second compartment 120. At block 308, the contacting layer 108 allows the fluid 103a from the second compartment 120 to permeate through the contacting layer 108 to establish fluid communication amongst the gas 101a in the first compartment 110, the fluid 103a, and a first electrode (such as the first electrode 104) that is disposed within the first compartment 110. While allowing the fluid 103a from the second compartment 120 to permeate through the contacting layer 108 at block 308, the gas 101a is restricted from flowing from the first compartment 110 through the contacting layer 108 to the second compartment 120 by the contacting layer 108 at block 310. In some implementations, a hydrophobic additive (such as the hydrophobic additive 114) disposed within the first compartment 110 and in contact with the first electrode 104 prevents clogging of pores of the first electrode 104 by the electrolyte present in the fluid 103a. At block 312, the first electrode 104 receives electrical power to establish a voltage across the first electrode 104 and a second electrode (such as the second electrode 106) that is disposed within the second compartment 120 and to facilitate a chemical reaction between the gas 101a and the fluid 103a.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the term “composite density” generally refers to the proportion of the mass of a material excluding the mass of the liquid to the total mass of the material including the mass of the liquid present in a given volume of the material during operation.

As used in this disclosure, the term “composite force density” generally refers to the number of groups that enable presence of attractive intermolecular forces with liquid in a given volume of liquid during operation. Examples of such forces include and result from, but are not limited to, ion induced dipole forces, ion-dipole forces, hydrogen bonding, van der Waals forces, adhesion, cohesion, surface tension etc.

As used in this disclosure, the term “ionic liquid” generally refers to a salt containing any of a variety of anions or cations that is substantially fluid (e.g., liquid) under ambient conditions. The salt may contain monovalent or polyvalent anions or cations. In addition, an ionic liquid may be a single salt or a mixture of salts.

As used in this disclosure, the term “(meth)acrylic” generally refers to either “acrylic” or “methacrylic”.

As used in this disclosure, the term “organic solvent” generally refers to a non-aqueous solvent and/or to a solvent containing an organic compound.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

### Embodiments

In an example implementation (or aspect), an electrochemical cell comprises: a housing defining: a first compartment; a gas inlet configured to receive a gas in the first compartment; a second compartment; and a fluid inlet configured to receive a fluid comprising an electrolyte in the second compartment; a first electrode disposed within the first compartment, wherein the first electrode is porous; a second electrode disposed within the second compartment; and a contacting layer disposed within the housing intermediate of the first compartment and the second compartment, wherein the contacting layer is configured to hermetically separate the first compartment from the second compartment, wherein the contacting layer is permeable to the fluid received within the second compartment for allowing the fluid to permeate through the contacting layer and establish fluid communication amongst the gas, the fluid, and the first electrode, wherein the contacting layer is configured to restrict flow of the gas from the first compartment through the contacting layer to the second compartment.

In an example implementation (or aspect) combinable with any other example implementation (or aspect), the electrochemical cell comprises a composite interlayer disposed within the second compartment.

In an example implementation (or aspect) combinable with any other example implementation (or aspect), the composite interlayer is porous for allowing multidirectional flow of the fluid through the second compartment and substantially equalizing pressure of the fluid within the composite interlayer across a specified dimension of the composite interlayer.

In an example implementation (or aspect) combinable with any other example implementation (or aspect), the contacting layer is multilayered.

In an example implementation (or aspect) combinable with any other example implementation (or aspect), the contacting layer comprises a composite microporous layer having a transverse permeability and a longitudinal permeability.

In an example implementation (or aspect) combinable with any other example implementation (or aspect), the transverse permeability of the composite microporous layer is greater than the longitudinal permeability of the composite microporous layer for maintaining the hermetic separation between the first compartment and the second compartment.

In an example implementation (or aspect) combinable with any other example implementation (or aspect), an external surface of the composite microporous layer is exposed to the first compartment.

In an example implementation (or aspect) combinable with any other example implementation (or aspect), the contacting layer comprises a composite support layer that is porous.

In an example implementation (or aspect) combinable with any other example implementation (or aspect), a fluid holding capacity of the composite support layer is greater than a fluid holding capacity of the composite microporous layer.

In an example implementation (or aspect) combinable with any other example implementation (or aspect), the composite support layer is configured to substantially equalize pressure of the fluid within the composite support layer across a specified dimension of the composite support layer.

In an example implementation (or aspect) combinable with any other example implementation (or aspect), an external surface of the composite support layer is exposed to the second compartment.

In an example implementation (or aspect) combinable with any other example implementation (or aspect), the electrochemical cell comprises a catalyst that is in electrical contact with the first electrode.

In an example implementation (or aspect) combinable with any other example implementation (or aspect), the hydrophobic additive comprises polytetrafluoroethylene, polyvinylidene fluoride, or both.

In an example implementation (or aspect) combinable with any other example implementation (or aspect), the electrochemical cell comprises a contacting additive in contact with the contacting layer, wherein the contacting additive comprises a water-miscible polymer.

In an example implementation (or aspect) combinable with any other example implementation (or aspect), the electrochemical cell comprises a hydrophobic additive disposed within the first compartment, wherein the first electrode is in contact with the hydrophobic additive within the first compartment, wherein the hydrophobic additive is configured to prevent clogging of pores of the first electrode by the electrolyte.

In an example implementation (or aspect), a method comprises: receiving a gas into a first compartment of an electrochemical cell; receiving a fluid comprising an electrolyte into a second compartment of the electrochemical cell; hermetically sealing, by a contacting layer of the electrochemical cell, the first compartment from the second compartment; allowing, by the contacting layer, the fluid from the second compartment to permeate through the contacting layer to establish fluid communication amongst the gas in the first compartment, the fluid, and a first electrode disposed within the first compartment; while allowing the fluid from the second compartment to permeate through the contacting layer, restricting flow of the gas from the first compartment through the contacting layer to the second compartment; and receiving, by the first electrode, electrical power to establish a voltage across the first electrode and a second electrode disposed within the second compartment and facilitate a chemical reaction between the gas and the fluid.

In an example implementation (or aspect) combinable with any other example implementation (or aspect), the method comprises substantially equalizing, by a composite interlayer that is porous and disposed within the second compartment, pressure of the fluid within the composite interlayer across a specified dimension of the composite interlayer.

In an example implementation (or aspect) combinable with any other example implementation (or aspect), the contacting layer is multilayered.

In an example implementation (or aspect) combinable with any other example implementation (or aspect), the contacting layer comprises a composite microporous layer having a transverse permeability and a longitudinal permeability.

In an example implementation (or aspect) combinable with any other example implementation (or aspect), the transverse permeability of the composite microporous layer is greater than the longitudinal permeability of the composite microporous layer.

In an example implementation (or aspect) combinable with any other example implementation (or aspect), an external surface of the composite microporous layer is exposed to the first compartment.

In an example implementation (or aspect) combinable with any other example implementation (or aspect), the method comprises maintaining, by the composite microporous layer, the hermetic separation between the first compartment and the second compartment.

In an example implementation (or aspect) combinable with any other example implementation (or aspect), the method comprises substantially equalizing, by a composite support layer of the contacting layer, pressure of the fluid within the composite support layer across a specified dimension of the composite support layer, wherein the composite support layer is porous, and an external surface of the composite support layer is exposed to the second compartment.

In an example implementation (or aspect) combinable with any other example implementation (or aspect), the method comprises accelerating, by a catalyst in electrical contact with the first electrode, the chemical reaction between the gas and the fluid.

In an example implementation (or aspect) combinable with any other example implementation (or aspect), the method comprises discharging a product gas from the first compartment, wherein the product gas comprises a reaction product of the chemical reaction between the gas and the fluid.

In an example implementation (or aspect) combinable with any other example implementation (or aspect), the method comprises discharging a product fluid from the second compartment, wherein the product fluid comprises a reaction product of the chemical reaction between the gas and the fluid, wherein the product fluid is a gaseous phase, a liquid phase, or a mixed phase comprising the gaseous phase and the liquid phase.

In an example implementation (or aspect), an electrochemical cell comprises: a housing defining: a first compartment; a first gas inlet configured to receive a gas in the first compartment; a second compartment; a fluid inlet configured to receive a fluid comprising an electrolyte in the second compartment; a third compartment; and a second gas inlet configured to receive a second gas in the third compartment, wherein the second compartment is intermediate of the first compartment and the third compartment; a first electrode disposed within the first compartment, wherein the first electrode is porous; a hydrophobic additive disposed within the first compartment, wherein the first electrode is in contact with the hydrophobic additive within the first compartment, wherein the hydrophobic additive is configured to prevent clogging of pores of the first electrode by the electrolyte; a second electrode disposed within the second compartment or the third compartment; a first contacting layer disposed within the housing intermediate of the first compartment and the second compartment, wherein the first contacting layer is configured to hermetically separate the first compartment from the second compartment, wherein the first contacting layer is permeable to the fluid received within the second compartment for allowing the fluid to permeate through the first contacting layer and establish fluid communication amongst the gas, the fluid, and the first electrode, wherein the first contacting layer is configured to restrict flow of the gas from the first compartment through the first contacting layer to the second compartment; and a second contacting layer disposed within the housing intermediate of the second compartment and the third compartment, wherein the second contacting layer is configured to hermetically separate the third compartment from the second compartment, wherein the second contacting layer is permeable to the fluid received within the second compartment for allowing the fluid to permeate through the second contacting layer and establish fluid communication between the second gas and the fluid, wherein the second contacting layer is configured to restrict flow of the second gas from the third compartment through the second contacting layer to the second compartment.

In an example implementation (or aspect) combinable with any other example implementation (or aspect), the electrochemical cell comprises a composite interlayer disposed within the second compartment, wherein the composite interlayer is porous for allowing multidirectional flow of the fluid through the second compartment and substantially equalizing pressure of the fluid within the composite interlayer across a specified dimension of the composite interlayer.

In an example implementation (or aspect) combinable with any other example implementation (or aspect), the first contacting layer is multilayered and comprises a first composite microporous layer and a first composite support layer that is porous.

In an example implementation (or aspect) combinable with any other example implementation (or aspect), the first composite microporous layer has a transverse permeability and a longitudinal permeability.

In an example implementation (or aspect) combinable with any other example implementation (or aspect), the transverse permeability of the first composite microporous layer is greater than the longitudinal permeability of the first composite microporous layer for maintaining the hermetic separation between the first compartment and the second compartment.

In an example implementation (or aspect) combinable with any other example implementation (or aspect), an external surface of the first composite microporous layer is exposed to the first compartment.

In an example implementation (or aspect) combinable with any other example implementation (or aspect), a fluid holding capacity of the first composite support layer is greater than a fluid holding capacity of the first composite microporous layer.

In an example implementation (or aspect) combinable with any other example implementation (or aspect), the first composite support layer is configured to substantially equalize pressure of the fluid within the first composite support layer across a specified dimension of the first composite support layer.

In an example implementation (or aspect) combinable with any other example implementation (or aspect), an external surface of the first composite support layer is exposed to the second compartment.

In an example implementation (or aspect) combinable with any other example implementation (or aspect), the second contacting layer is multilayered and comprises a second composite microporous layer and a second composite support layer that is porous.

In an example implementation (or aspect) combinable with any other example implementation (or aspect), the second contacting layer comprises a second composite microporous layer having a transverse permeability and a longitudinal permeability.

In an example implementation (or aspect) combinable with any other example implementation (or aspect), the transverse permeability of the second composite microporous layer is greater than the longitudinal permeability of the second composite microporous layer for maintaining the hermetic separation between the second compartment and the third compartment.

In an example implementation (or aspect) combinable with any other example implementation (or aspect), an external surface of the second composite microporous layer is exposed to the third compartment.

In an example implementation (or aspect) combinable with any other example implementation (or aspect), a fluid holding capacity of the second composite support layer is greater than a fluid holding capacity of the second composite microporous layer.

In an example implementation (or aspect) combinable with any other example implementation (or aspect), the second composite support layer is configured to substantially equalize pressure of the fluid within the second composite support layer across a specified dimension of the second composite support layer.

In an example implementation (or aspect) combinable with any other example implementation (or aspect), an external surface of the second composite support layer is exposed to the second compartment.

In an example implementation (or aspect) combinable with any other example implementation (or aspect), the electrochemical cell comprises a catalyst that is in electrical contact with the first electrode.

In an example implementation (or aspect) combinable with any other example implementation (or aspect), the electrochemical cell comprises a contacting additive in contact with at least one of the first contacting layer or the second contacting layer, wherein the contacting additive comprises a water-miscible polymer.

What is claimed is:

1. An electrochemical cell comprising:
a housing defining:
a first compartment;
a gas inlet configured to receive a gas in the first compartment;
a second compartment; and
a fluid inlet configured to receive a fluid comprising an electrolyte in the second compartment;
a first electrode disposed within the first compartment, wherein the first electrode is porous;
a second electrode disposed within the second compartment; and
a contacting layer disposed within the housing intermediate of the first compartment and the second compartment, wherein the contacting layer is configured to hermetically separate the first compartment from the second compartment, wherein the contacting layer is permeable to the fluid received within the second compartment for allowing the fluid to permeate through the contacting layer and establish fluid communication amongst the gas, the fluid, and the first electrode, wherein the contacting layer is configured to restrict flow of the gas from the first compartment through the contacting layer to the second compartment.

2. The electrochemical cell of claim 1, comprising a composite interlayer disposed within the second compartment, wherein the composite interlayer is porous for allowing multidirectional flow of the fluid through the second compartment and substantially equalizing pressure of the fluid within the composite interlayer across a specified dimension of the composite interlayer.

3. The electrochemical cell of claim 2, wherein:
the contacting layer is multilayered;
the contacting layer comprises a composite microporous layer having a transverse permeability and a longitudinal permeability;
the transverse permeability of the composite microporous layer is greater than the longitudinal permeability of the composite microporous layer for maintaining the hermetic separation between the first compartment and the second compartment; and
an external surface of the composite microporous layer is exposed to the first compartment.

4. The electrochemical cell of claim 3, wherein the contacting layer comprises a composite support layer that is porous, wherein a fluid holding capacity of the composite support layer is greater than a fluid holding capacity of the composite microporous layer, wherein the composite support layer is configured to substantially equalize pressure of the fluid within the composite support layer across a specified dimension of the composite support layer, wherein an external surface of the composite support layer is exposed to the second compartment.

5. The electrochemical cell of claim 4, comprising a catalyst that is in electrical contact with the first electrode.

6. The electrochemical cell of claim 5, wherein the hydrophobic additive comprises polytetrafluoroethylene, polyvinylidene fluoride, or both.

7. The electrochemical cell of claim 6, comprising a contacting additive in contact with the contacting layer, wherein the contacting additive comprises a water-miscible polymer.

8. The electrochemical cell of claim 7, comprising a hydrophobic additive disposed within the first compartment, wherein the first electrode is in contact with the hydrophobic additive within the first compartment, wherein the hydrophobic additive is configured to prevent clogging of pores of the first electrode by the electrolyte.

9. A method comprising:
receiving a gas into a first compartment of an electrochemical cell;
receiving a fluid comprising an electrolyte into a second compartment of the electrochemical cell;
hermetically sealing, by a contacting layer of the electrochemical cell, the first compartment from the second compartment;
allowing, by the contacting layer, the fluid from the second compartment to permeate through the contacting layer to establish fluid communication amongst the gas in the first compartment, the fluid, and a first electrode disposed within the first compartment;
while allowing the fluid from the second compartment to permeate through the contacting layer, restricting flow of the gas from the first compartment through the contacting layer to the second compartment; and
receiving, by the first electrode, electrical power to establish a voltage across the first electrode and a second electrode disposed within the second compartment and facilitate a chemical reaction between the gas and the fluid.

10. The method of claim 9, comprising substantially equalizing, by a composite interlayer that is porous and disposed within the second compartment, pressure of the fluid within the composite interlayer across a specified dimension of the composite interlayer.

11. The method of claim 10, wherein:
the contacting layer is multilayered;
the contacting layer comprises a composite microporous layer having a transverse permeability and a longitudinal permeability;
the transverse permeability of the composite microporous layer is greater than the longitudinal permeability of the composite microporous layer;
an external surface of the composite microporous layer is exposed to the first compartment; and
the method comprises maintaining, by the composite microporous layer, the hermetic separation between the first compartment and the second compartment.

12. The method of claim 11, comprising substantially equalizing, by a composite support layer of the contacting layer, pressure of the fluid within the composite support layer across a specified dimension of the composite support layer, wherein the composite support layer is porous, and an external surface of the composite support layer is exposed to the second compartment.

13. The method of claim 12, comprising accelerating, by a catalyst in electrical contact with the first electrode, the chemical reaction between the gas and the fluid.

14. The method of claim 13, comprising discharging a product gas from the first compartment, wherein the product gas comprises a reaction product of the chemical reaction between the gas and the fluid.

15. The method of claim 13, comprising discharging a product fluid from the second compartment, wherein the product fluid comprises a reaction product of the chemical reaction between the gas and the fluid, wherein the product fluid is a gaseous phase, a liquid phase, or a mixed phase comprising the gaseous phase and the liquid phase.

16. An electrochemical cell comprising:
a housing defining:
a first compartment;
a first gas inlet configured to receive a gas in the first compartment;
a second compartment;
a fluid inlet configured to receive a fluid comprising an electrolyte in the second compartment;
a third compartment; and
a second gas inlet configured to receive a second gas in the third compartment, wherein the second compartment is intermediate of the first compartment and the third compartment;
a first electrode disposed within the first compartment, wherein the first electrode is porous;
a hydrophobic additive disposed within the first compartment, wherein the first electrode is in contact with the hydrophobic additive within the first compartment, wherein the hydrophobic additive is configured to prevent clogging of pores of the first electrode by the electrolyte;
a second electrode disposed within the second compartment or the third compartment;
a first contacting layer disposed within the housing intermediate of the first compartment and the second compartment, wherein the first contacting layer is configured to hermetically separate the first compartment from the second compartment, wherein the first contacting layer is permeable to the fluid received within the second compartment for allowing the fluid to permeate through the first contacting layer and establish fluid communication amongst the gas, the fluid, and the first electrode, wherein the first contacting layer is configured to restrict flow of the gas from the first compartment through the first contacting layer to the second compartment; and
a second contacting layer disposed within the housing intermediate of the second compartment and the third compartment, wherein the second contacting layer is configured to hermetically separate the third compartment from the second compartment, wherein the second contacting layer is permeable to the fluid received within the second compartment for allowing the fluid to permeate through the second contacting layer and establish fluid communication between the second gas and the fluid, wherein the second contacting layer is configured to restrict flow of the second gas from the third compartment through the second contacting layer to the second compartment.

17. The electrochemical cell of claim 16, comprising a composite interlayer disposed within the second compartment, wherein the composite interlayer is porous for allowing multidirectional flow of the fluid through the second compartment and substantially equalizing pressure of the fluid within the composite interlayer across a specified dimension of the composite interlayer.

18. The electrochemical cell of claim 17, wherein:
the first contacting layer is multilayered and comprises a first composite microporous layer and a first composite support layer that is porous;
the first composite microporous layer has a transverse permeability and a longitudinal permeability;
the transverse permeability of the first composite microporous layer is greater than the longitudinal permeability of the first composite microporous layer for maintaining the hermetic separation between the first compartment and the second compartment;
an external surface of the first composite microporous layer is exposed to the first compartment;
a fluid holding capacity of the first composite support layer is greater than a fluid holding capacity of the first composite microporous layer;
the first composite support layer is configured to substantially equalize pressure of the fluid within the first composite support layer across a specified dimension of the first composite support layer; and
an external surface of the first composite support layer is exposed to the second compartment.

19. The electrochemical cell of claim 18, wherein:
the second contacting layer is multilayered and comprises a second composite microporous layer and a second composite support layer that is porous;
the second contacting layer comprises a second composite microporous layer having a transverse permeability and a longitudinal permeability;
the transverse permeability of the second composite microporous layer is greater than the longitudinal permeability of the second composite microporous layer for maintaining the hermetic separation between the second compartment and the third compartment;
an external surface of the second composite microporous layer is exposed to the third compartment;
a fluid holding capacity of the second composite support layer is greater than a fluid holding capacity of the second composite microporous layer;
the second composite support layer is configured to substantially equalize pressure of the fluid within the second composite support layer across a specified dimension of the second composite support layer; and
an external surface of the second composite support layer is exposed to the second compartment.

20. The electrochemical cell of claim 18, comprising:
a catalyst that is in electrical contact with the first electrode; and
a contacting additive in contact with at least one of the first contacting layer or the second contacting layer, wherein the contacting additive comprises a water-miscible polymer.
